(19) United States
(12) Patent Application Publication
(10) Pub. No.: US 2019/0084885 A1
(43) Pub. Date: Mar. 21, 2019

(54) FOAMING AGENT AND DISPERSANT COMBINATIONS FOR GYPSUM COMPOSITIONS

(71) Applicant: ALLIED FOAM TECH CORP., Montgomeryville, PA (US)

(72) Inventor: Yen-Yau CHAO, Harleysville, PA (US)

(21) Appl. No.: 16/135,642

(22) Filed: Sep. 19, 2018

Related U.S. Application Data
(60) Provisional application No. 62/561,311, filed on Sep. 21, 2017.

(51) Int. Cl. C04B 28/14; C04B 24/16

(52) U.S. Cl. CPC C04B 28/145; C04B 2103/404; C04B 24/161

(57) ABSTRACT

A lightweight gypsum compositions gypsum composition with good water resistance having a low water-to-stucco ratio, high flowability, and mechanical strength. The gypsum composition includes a cationic agent, an anionic agent, an aqueous stucco slurry containing a stucco, a water reducing dispersant, and water. The cationic agent may operate as a foaming agent, and the anionic agent may operate as a foam stabilizer.

### CROSS REFERENCE TO RELATED APPLICATIONS

This application claims the benefit of Provisional U.S. Patent Application No. 62/561,311, filed Sep. 21, 2017, the entire disclosure of which is herein incorporated by reference.

### FIELD OF INVENTION

The present invention relates generally to lightweight gypsum compositions, specifically to gypsum compositions having good water resistance, low water-to-stucco ratio, and high mechanical strength.

### BACKGROUND OF THE INVENTION

Lightweight gypsum-based building products are widely used in the construction industry in the form of ceiling panels and wall panels or boards. Gypsum wallboards are made with a foamed core and fiberglass or paper cover. The foamed gypsum core is mostly made of calcium sulfate hemihydrate, water, and foam. The manufacturing process involves a continuous deposition of highly flowable gypsum core onto a cover stock moving at high speed beneath a foam-gypsum slurry mixer. A second or top cover stock is applied thereover. The composite is formed into the shape of a panel, which is cut to length and stacked for drying in a drying kiln.

During the manufacturing process calcium sulfate hemihydrate reacts with excess amount of water to cause the hemihydrate to set and become hard through a matrix of interlocking calcium sulfate dihydrate crystals. To make the core material flow quickly on the cover sheet at a precisely gauged thickness, an excess amount of water, as high as 90-120% of the dry weight of the calcium sulfate hemihydrate, is typically used, although the amount of water needed to convert the dry powder into the dihydrate crystals is only ˜20%. The wet composite boards are conveyed through a drying kiln to remove the excess water. Energy consumption in this drying step is very high. It was estimated that a modern gypsum board line, running typically at 330 feet/min, must evaporate about 1,100 lbs./min of water, with an energy consumption in excess of 1.2 million kJ/min.

During the gypsum board manufacturing, more than 80% of the water consumed for quick slurry flow must be eventually driven off through evaporation by heat in the drying kiln. A reduction in production costs could be realized if one can reduce the amount of water used in the board mix and still can keep the stucco mix flow effectively in the high-speed production line. Water reducing dispersants were known to reduce water to cement ratios in formulating concrete and cement mixes. However, efforts in the gypsum industry to apply such water reducing dispersants in a foamed gypsum slurry were not successful. Most cases, especially the use of polysulfonate-containing water reducing dispersants in a foamed gypsum slurry, resulted in very low foam efficiency, significant foam collapse, and/or significant coarse foam texture formation. Such adverse effects are mainly caused by the incompatibility between anionic foam agents and such dispersants in the gypsum slurries.

Attempts have been made to improve the foam stability through manufacturing new types of foam agents and multi-step addition of different foam agents. New types of dispersants have been synthesized in an attempt to solve such compatibility issues. However, such measures often caused significant undesirable effects.

There have been also other efforts to reduce the effect of such incompatibility between the anionic foaming agents and the water reducing dispersants by greatly reducing the dosage of the water reducing dispersants. However, such measures not only greatly curtail the intended purpose of achieving a low water-to-stucco ratio (WSR) to save energy, but also produce gypsum boards with big voids or coarsened pores. This often resulted in poor mechanical strength of the final product. Therefore, it is highly desirable to achieve a stable foam in a gypsum slurry with a low WSR.

### SUMMARY OF THE INVENTION

It is therefore an objective of the present invention to provide a foam composition that is fully compatible and stable with water reducing dispersants present in gypsum slurry compositions. Such a foam composition can maintain full foam efficiency and fine pore size.

It is also an objective of the present invention to provide a process of preparing a gypsum foam composition where a preformed aqueous foam is added into polynaphthalene sulfonate (PNS)-containing stucco or calcined gypsum composition at an appreciably reduced WSR relative to that of the conventional foamed gypsum slurries.

It is also an objective of this invention to provide a foamed gypsum composition with improved mechanical strength, water resistance, and greatly reduced energy consumption during the manufacturing of the product.

It is also an objective of the present invention to use, as part of its foam composition, an alkyl quaternary ammonium salt with antifungal activity for making a foamed gypsum composition.

It is also an objective of the present invention to provide a foamed gypsum composition that has the high fluidity required for high speed gypsum board production with appreciably less water to be evaporated during the making of the gypsum product.

It is also an objective of the present invention to provide a foamed gypsum composition that has much lower water absorption than that of the conventional commercial gypsum product at the same densities.

It is also an objective of the present invention to provide a foamed gypsum block, board, cavity insulations, fillings, and ceiling tiles with good water and fungus resistance that could allow such products to be used in wet or exterior applications where such performances are needed.

### DETAILED DESCRIPTION OF THE INVENTION

A foamed gypsum composition of the present invention with good water resistance, low water-to-stucco ratio (WSR), high flowability, and high mechanical strength is made with a cationic agent; an anionic agent; and an aqueous stucco slurry containing a stucco, a water reducing dispersant, and water, wherein the WSR of the aqueous slurry is less than 0.85. The cationic agent may operate as a foaming agent, and the anionic agent may operate as a foam stabilizer.

One type of the cationic agents of the present invention is a long-chain organic cation-forming compound having Formula (I):

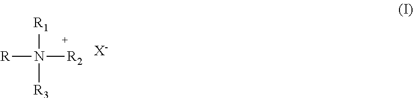

wherein R is an aliphatic hydrocarbon radical having 8-24 carbon atoms; R₁ is selected from the group consisting of an alkyl group having 1-16 carbon atoms, a hydroxyalkyl group having 1-16 carbon atoms, a benzyl group, a group which, when taken together with the nitrogen, represents a heterocyclic radical, and any of such groups having a hydrogen atom replaced by a fluorine atom; R₂ and R₃ are selected from the group consisting of an alkyl group having 1-6 carbon atoms, a hydroxyalkyl group having 1-6 carbon atoms, a benzyl group, a hydrogen atom, a group which, when taken together with the nitrogen, represents a heterocyclic radical, and any of such groups having a hydrogen atom replaced by a fluorine atom; and X⁻ is an anionic counter ion. Such cationically charged foam surface is effective in its anti-fungal activity due to the greatly increased cationically charged surface. The partial locking of the antifungal agent with the anionic foam stabilizer may allow slow release of the antifungal agent over a long period of time to reduce toxicity of the antifungal agent in one-time application.

One type of the anionic agent of the present invention is a long-chain organic anion-forming compound having Formula (II):

R′—X₂⁻Y⁺ (II)

wherein R′ is an aliphatic hydrocarbon radical with 10 to 24 carbon atoms; X2⁻ is an anionic group selected from the group consisting of carboxylate, sulfate, sulfonate, and phosphate; and Y⁺ is a cationic counter ion selected from the group consisting of ammonium, sodium, and potassium salt. In one embodiment, the long-chain organic cation formed from (I) and the long-chain organic anion formed from (II) are present in a weight ratio of from 0.05:1 to 15:1, preferably 0.4:1 to 10:1, more preferably 0.5:1 to 5:1.

A gypsum base material from which the lightweight gypsum composition of the present invention may be made is the hemihydrate form of calcium sulfate (CaSO₄·½H₂O), commonly termed “stucco,” which is produced by heat conversion of the dihydrate form of calcium sulfate (CaSO₄·2H₂O), from which 1½ water molecules been removed. The hemihydrate is produced in at least two crystal forms—the alpha-calcined gypsum and the beta-calcined gypsum.

One type of the water reducing dispersants of the present invention is a sulfonate-containing plasticizer such as the lignosulfonates, or superplasticizer such as the polynaphthalene sulfonate condensate (PNS) having a weight average molecular weight of from about 8,000 to about 14,000. The naphthalenesulfonate dispersants used in the present invention include the alkali salt of polynaphthalenesulfonic acid, the condensation products of naphthalenesulfonic acids and formaldehyde. Particularly desirable polynaphthalenesulfonates include sodium and calcium naphthalenesulfonate. They are preferably used as aqueous solutions in the range 35-55 weight % of the solid contents. Alternatively, the naphthalenesulfonates can be used in dry solid or powder form.

In one embodiment, gypsum accelerators are used. The gypsum accelerators may enhance the efficiency of hydration and regulate setting of gypsum. Accelerators may include finely ground dry calcium sulfate dihydrate, referred to as “gypsum seeds or ground gypsum”. They may be used together with sugar or starch. The gypsum seeds may enhance nucleation of the set gypsum crystals, thereby increasing the crystallization rate thereof. Potassium or ammonium sulfates may be used as set accelerators.

In one embodiment, gypsum retarders are used. The gypsum retarders may be a chelating agent selected from at least one of sodium citrate, citric acid, tartaric acid, sodium tartrate, a sodium salt of polyacrylic acid, an acrylic acid sulfonic acid copolymer, an ammonium salt of an acrylic acid sulfonic acid copolymer, a sodium salt of an acrylic acid sulfonic acid copolymer, and a blend of an acrylic acid polymer with a sulfonic acid copolymer and salts thereof.

In one embodiment, glass fibers are used. Glass fiber mats or fiberglass scrims may be used as facer materials upon impregnation with the foamed gypsum slurry of the present invention to replace the paper cover sheet for the gypsum boards.

Fibers used in the present invention may be organic and mineral fibers such as polyvinyl alcohol, nylon, polypropylene, basalt, rayon, cellulose, steel, wood, aramid, polyester, acrylic, and others are able to be spun into very different deniers or dtex numbers and cut to different lengths. These fibers have high fiber strength, and those with low dtex or fine deniers also have a great number of fibrils per unit weight that allows very cost-effective means of using such fibers.

In one embodiment, water resistant additives are used. Additives for improving water resistance of gypsum boards such as wax or asphalt emulsions, and silicon oil may also be used to improve the water resistance of gypsum boards of the present invention.

### EXAMPLES

### Example1

### Aqueous Foam Preparation for the Samples of the Present Invention

An aqueous foam for the gypsum slurry composition of the present invention is prepared by adding an anionic agent such as potassium stearate to a preformed foam containing a cationic agent such as hexadecyltrimethylammonium chloride as follows:

100 grams of water is mixed with 5 grams of the cationic agent. The mixture is added into a five-quart stainless steel bowl. The content is whipped at speed ten in a Hobart blender (Kitchen Aid brand) until a low-density foam having a density of 0.03-0.08 g/cc is obtained. This usually takes one to three minutes. 5 grams of the anionic agent is then added onto the preformed foam in the blender under continuous mixing. The mixing is continued until a homogeneous foam mix is obtained. This takes one to two minutes. The cationic and the anionic agents may be at least one of the compounds of Formula (I) and Formula (II), respectively.

### Example 2

### Aqueous Foam Preparation for the Comparative Samples

An aqueous foam for comparative samples is prepared by mixing 100 grams of water with 5 grams of an anionic agent such as potassium stearate. The mixture is added into a five-quart stainless steel bowl. The content is whipped at speed ten in a Hobart blender (Kitchen Aid brand) until a low-density foam having a density of 0.03-0.08 g/cc is obtained. This usually took one to three minutes.

### Example 3

### Gypsum Slurry Preparation at Various Water-to-Stucco Ratios (WSRs)

A gypsum slurry of the present invention, is prepared by adding a pre-weighed amount of calcined gypsum or stucco into a pre-weighed amount of water containing 0.3-3.0 weight percent (based on the weight of the gypsum powder) high range water reducing dispersant. The weight percent of the water reducing dispersant to the stucco is from 0.1 to 20%, preferably 0.1 to 10%, more preferably 0.1 to 5%. The weight ratio of the water used to that of the stucco is then expressed as WSR (water-to-stucco ratio). The water reducing dispersant may be at least one of the compounds described above, including polynaphthalenesulfonate (PNS).

High shear mixing (>500 rpm) with an industrial dispersing blade is usually applied to the aqueous stucco mixes for 1 minute. Gypsum retarders may be used to delay the setting of hydrating stucco if the setting is too fast. Ground gypsum accelerator may also be used to accelerate the setting if too much retarder causes delay in setting. Such additives may be added into the gypsum slurry or added into the preformed foam of the present invention.

### Example 4

### Water Uptake Test by Totally Submerging the Gypsum Samples in Water

A completely dried foam gypsum block of dimensions 2 inch ×2 inch ×2 inch is placed in a plastic container containing 4 inches deep of water. The test samples are placed into the container and a metal net is applied on top of the container to keep all the samples at least 0.5 inch below the water surface. The weight of the gypsum block is weighed before submerging and weighed after being submerged for a fixed period of time. Upon weighing the water soaked sample, a dry paper towel may be used to wipe the excess amount of water off the sample surface before weighing. The soaking time and the weight are then recorded.

### Example 5

### Water Uptake Test by Partially Soaking the Gypsum Samples in Water

A completely dried foam gypsum block of dimensions 2 inch ×2 inch ×2 inch is placed in a pan containing water having a depth of 0.5 inch. The weight of the gypsum block is weighed before soaking and weighed after soaking for a fixed amount of time. Upon weighing the water soaked sample, a dry paper towel may be used to wipe the excess amount of water off the sample surface before weighing. The soaking time and the weight are then recorded.

TABLE I

| | Sample 1 | | | |
|---|---|---|---|---|
| | (comparative) | | Sample 2 | |
| Composition: | | | | |
| Slurry | | | | |
| Stucco | 400 | grams | 400 | grams |
| Water | 320 | grams | 320 | grams |
| Water reducing | 1.2 | grams | 1.2 | grams |
| dispersant | | | | |
| Foam Added | 30 | grams | 30 | grams |
| | (5% aqueous | | (5% aqueous | |
| | anionic agent) | | cationic & anionic agents) | |
| Foamed Gypsum Slurry: | | | | |

| | | |
|---|---|---|
| Water to Stucco Ratio | 0.8 | 0.8 |
| (WSR) | | |
| Dry density (lbs./cubic | >60 | 27 |
| foot) | | |
| Stability of Foamed | 100% foam | 0% foam |
| Gypsum Slurry | collapse | collapse |

Aqueous foam preparation in Table I is described either in EXAMPLE 1 for the foam composition of the present invention or in EXAMPLE 2 for the comparative foam sample.

For the comparative Sample 1, upon addition of the preformed foam to the gypsum slurry containing PNS water reducing dispersant, 100% foam collapse took place before the foamed stucco started to set, and the dry density was greater than 60 pcf (lbs. per cubic foot), while the foamed stucco of the present invention Sample 2 showed 0% foam collapse at the same level of PNS dispersant present in the stucco slurry and the dry density was 27 pcf.

TABLE II

| | Sample 3 | | | |
|---|---|---|---|---|
| | (comparative) | | Sample 4 | |
| Composition: | | | | |
| Slurry | | | | |
| Stucco | 400 | grams | 400 | grams |
| Water | 160 | grams | 160 | grams |
| Water reducing | 0 | grams | 1.2 | grams |
| dispersant | | | | |
| Wax emulsion | 10 | grams | 10 | grams |
| Foam added | 30 | grams | 30 | grams |
| | (3% aqueous cationic | | (3% aqueous cationic | |
| | & anionic agents) | | & anionic agents) | |
| Foamed Gypsum Slurry: | | | | |
| Water to Stucco Ratio | 0.4 | | 0.4 | |
| (WSR) | | | | |
| Dry density (lbs./cubic | 36 | | 41 | |
| foot) | | | | |
| Fluidity before setting | Thick, not | | Flowable | |
| | flowable | | | |
| Viscosity | >600 | cps | <100 | cps |

| | | |
|---|---|---|
| Compressive strength | 190 psi (lbs./ | 440 psi (lbs./ |
| | sq. inch) | sq. inch) |

Comparative Sample 3 in Table II shows that, when WSR is reduced to 0.40 without a water reducing dispersant, the foamed stucco was thick and non-flowable. The compressive strength was only 190 psi. For Sample 4 of the present invention with 1.2 grams of water reducing dispersant in the stucco slurry, the foamed stucco flowed easily at a WSR of 0.40 and the compressive strength reached 440 psi.

TABLE III

| | Sample 5 | | |
|---|---|---|---|
| | (comparative) | Sample 6 | |
| Composition: | | | |
| Slurry | | | |
| Stucco | Commercial ½″ | 400 | grams |
| | gypsum board | | |
| | (USG Ultralight) | | |
| Water | 0 gram | 240 | grams |
| Water reducing | 0 gram | 4.0 | grams |
| dispersant | | | |
| Gypsum retarder | 0 gram | 0.4 | grams |
| Ground gypsum | 0 gram | 2.0 | grams |
| (accelerator) | | | |
| Foam added | 0 gram | 40 | grams |
| | | (3% aqueous cationic | |
| | | & anionic agents) | |
| Foamed Gypsum Slurry: | | | |

| | | |
|---|---|---|
| Water to Stucco Ratio | | 0.6 |
| (WSR) | | |
| Density (lbs./cubic foot) | 35 | 35 |
| Water uptake in one hour | 48% | 20% |
| (in Water Submerge Test) | | |

Table III presents a water submerge test described in EXAMPLE 4. Table III shows that the Comparative Sample 5, a standard ½″ thick commercial gypsum board at a dry density of 35 pcf, yields a water uptake of 48% after the sample was submerged for 1 hour in water, while Sample 6 of the present invention without any water-resistant additives showed only 20% water uptake after submerged in water for 1 hour.

TABLE IV

| | Sample 7 | | | |
|---|---|---|---|---|
| | (comparative) | | Sample 8 | |
| Composition: | | | | |
| Slurry | | | | |
| Stucco | 400 | grams | 400 | grams |
| Water reducing | 0 | gram | 4.0 | grams |
| dispersant | | | | |
| Gypsum retarder | 0.4 | grams | 0.4 | grams |
| Ground gypsum | 2.0 | grams | 2.0 | grams |
| (accelerator) | | | | |
| Foam added | 30 | grams | 30 | grams |
| | (3% aqueous cationic | | (3% aqueous cationic | |
| | & anionic agents) | | & anionic agents) | |
| Foamed Slurry: | | | | |

| | | |
|---|---|---|
| Water to Stucco Ratio | 0.45 | 0.45 |
| (WSR) | | |
| Density (lbs./cubic | 36 | 41 |
| foot) | | |
| Water uptake in one | 32% | 11% |
| hour (in Partial | | |
| Water Soak Test) | | |

Table IV presents a partial water soak test described in EXAMPLE 5. Table IV shows that, in the partial water soak test, Comparative Sample 7 with a foamed stucco at WSR=0.45 and without the presence of water reducing dispersant in the stucco slurry showed a water uptake of 32% after the sample was partially soaked in water for 1 hour, while Sample 8 of the present invention at WSR=0.45 and with 1% water reducing dispersant in the stucco slurry showed only 11% water uptake over the same period in the partial water soak test.

TABLE V

| | Sample 9 | | | |
|---|---|---|---|---|
| | (comparative) | | Sample 10 | |
| Composition: | | | | |
| Gypsum Slurry | | | | |
| Stucco | 400 | grams | 400 | grams |
| Water | 160 | grams | 160 | grams |
| Water reducing dispersant | 4.0 | grams | 4.0 | grams |
| Preformed Foam Composition | | | | |
| Water | 100 | grams | 100 | grams |
| Foam agent (cationic agent) | 5 | grams | 5 | grams |
| Foam stabilizer (anionic | 0 | gram | 5 | grams |
| agent) | | | | |
| NYCON-PVA RECS15 fiber | 0 | gram | 30 | grams |
| Aqualite 81 wax emulsion | 0 | gram | 60 | grams |
| Gypsum retarder | 0 | gram | 0.4 | gram |
| Ground gypsum (accelerator) | 0 | gram | 2.0 | grams |
| Foam added | 0 | gram | 30 | grams |
| | | | (3% aqueous cationic | |
| | | | & anionic agents) | |
| Stability of foamed gypsum | Total collapse in | | 0% collapse | |
| | less than 1 min. | | until fully set | |
| Density of Foamed Gypsum | >80 | pcf | 41 | pcf |
| Slurry (wet) | | | | |

In Table V, Comparative Sample 9 shows a total foam collapse in less than 1 minute before the foam mix was added into the dispersant containing gypsum slurry while the preform of the present invention Sample 10 has fine foam texture without any foam collapse upon mixing of all gypsum additives.

The foamed additive mix, after mixing with the gypsum slurry with the water reducing dispersant, produced a foamed gypsum slurry with all the desirable flow and weight reduction efficiency expected. The set and dried foam gypsum produced the desirable lightweight and mechanical performance as expected.

In Table V, Sample 10 further shows the advantage of using the stable foam of the present invention that allows the separation of the gypsum retarder (in the gypsum mix) from the gypsum accelerator (in the preformed foam mix). This allows a good control of setting time of the foamed gypsum slurry suitable for different line speeds.

1. A gypsum composition comprising:
a cationic agent;
an anionic agent; and
an aqueous stucco slurry containing a stucco, a water reducing dispersant, and water, wherein the water-to-stucco ratio (WSR) of the aqueous slurry is less than 0.85.

2. The gypsum composition of claim 1, wherein the cationic agent is a quaternary antifungal foam agent, the anionic agent is a foam stabilizer, and the water reducing dispersant is a polysulfonate-containing dispersant, superplasticizers or plasticizers.

3. The gypsum composition of claim 2, wherein the WSR is between 0.35 and 0.80.

4. The gypsum composition of claim 2, wherein the cationic agent is a quaternary salt selected from the group consisting of dodecyltrimethylammonium bromide, dodecyltrimethylammonium chloride, tetradecyltrimethylammonium bromide, tetradecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammonium bromide, (tallow)trimethylammonium chloride, and a mixture thereof.

5. The gypsum composition of claim 2, wherein the anionic agent is a long-chain organic compound having Formula (II):
R′—X₂⁻Y⁺ (II)
where R′ is an aliphatic hydrocarbon radical with 10 to 24 carbon atoms; X₂⁻ is an anionic group selected from the group consisting of carboxylate, sulfate, sulfonate, and phosphate; and Y⁺ is a cationic counter ion selected from the group consisting of ammonium, sodium, and potassium salt.

6. The gypsum composition of claim 2, wherein the weight ratio of the cationic agent to anionic agent is from 0.1:1 to 15:1.

7. The gypsum composition of claim 3, wherein the weight ratio of the cationic agent to anionic agent is from 0.4:1 to 10:1.

8. The gypsum composition of claim 2, wherein the cationic agent is selected from the group consisting of hexadecyltrimethylammonium bromide, cetyltrimethylammonium bromide, cetyl pyridinium chloride, and a combination thereof.

9. The gypsum composition of claim 2, wherein the anionic agent is selected from the group consisting of ammonium, sodium, potassium salt of a carboxylic acid with alkyl chain length from C10 to C20, and a combination thereof.

10. The gypsum composition of claim 2, wherein the water reducing dispersant is selected from the group consisting of lignosulfonates, sulfonated melamine-formaldehyde condensates (SMF), sulphonated naphthalene-formaldehyde condensates (SNF), modified lignosulphonates (MLS), and a combination thereof.

11. The gypsum composition of claim 2, wherein the weight percent of the water reducing dispersant to the stucco is from 0.1 to 20%.

12. The gypsum composition of claim 2, wherein the water reducing dispersant is a polynaphthalenesulfonate superplasticizer the weight percent of the water reducing dispersant to the stucco is from 0.1 to 10%.

13. The gypsum composition of claim 2, further comprising gypsum retarders, accelerators, starch, polymer binders, silicon, wax, and/or asphalt water resistant additives.
